(19) United States
(12) Patent Application Publication
(10) Pub. No.: US 2016/0189871 A1
(43) Pub. Date: Jun. 30, 2016

(54) METHOD FOR MANUFACTURING CHEMICAL CONVERSION TREATED TUNGSTEN ANODE BODY, SOLID ELECTROLYTIC CAPACITOR ELEMENT AND SOLID ELECTROLYTIC CAPACITOR

(71) Applicant: SHOWA DENKO K.K., Tokyo (JP)

(72) Inventors: Kazumi NAITO, Tokyo (JP); Katsutoshi TAMURA, Tokyo (JP)

(21) Appl. No.: 14/973,477

(22) Filed: Dec. 17, 2015

(30) Foreign Application Priority Data
Dec. 25, 2014 (JP) 2014-262932

(51) Int. Cl. H01G 9/00

(52) U.S. Cl. CPC H01G 9/0032

(57) ABSTRACT

Disclosed is a method for manufacturing a chemical conversion treated tungsten anode body includes a chemical conversion treatment step of subjecting the surface of a tungsten anode body to a chemical conversion treatment to form a dielectric layer, and a high-temperature treatment step of exposing the tungsten anode body with the dielectric layer formed thereon to an atmosphere having a temperature of 270° C. or more and 370° C. or less for a period of 3 to 8 minutes.

### CROSS-REFERENCE TO RELATED APPLICATIONS

This application claims priority to Japanese Patent Application No. 2014-262932 filed on Dec. 25, 2014, the disclosure of which including the specification, the drawings, and the claims is hereby incorporated by reference in its entirety.

### BACKGROUND OF THE INVENTION

1. Field of the Invention

The present invention relates to a method for manufacturing a chemical conversion treated tungsten anode body, a solid electrolytic capacitor element and a solid electrolytic capacitor.

2. Description of Related Art

Solid electrolytic capacitor elements are composed of an anode body formed from a conductor such as a sintered body of a valve action metal powder, a dielectric layer formed on the surface of the anode body by subjecting the surface layer of the anode body to electrolytic oxidation in an aqueous solution of an electrolyte, and a cathode formed from a conductive polymer semiconductor layer of a conductive polymer formed on the dielectric layer by electrolytic polymerization or the like and a conductor layer formed on the conductive polymer semiconductor layer.

In order to enhance the performance of solid electrolytic capacitors, investigations have been conducted into the valve action metal used for the anode body. For example, Patent Document 1 discloses capacitors which use an anode body formed from a sintered body of a tantalum powder or a niobium powder. In addition to anode bodies using these types of metal powders, Patent Documents 2 and 3 disclose solid electrolytic capacitors which use a sintered body of a tungsten powder for the anode body. A solid electrolytic capacitor which uses a sintered body of a tungsten powder for the anode body is able to manufacture a larger capacitance than solid electrolytic capacitors which use sintered body of other valve action metals. However, solid electrolytic capacitors which use a sintered body of a tungsten powder for the anode body tend to suffer from a large leakage current, and various investigations are being pursued with the aim of resolving this issue.

### CITATION LIST

### Patent Documents

Patent Document 1: Japanese Unexamined Patent Application, First Publication No. 2013-74282

Patent Document 2: Japanese Unexamined Patent Application, First Publication No. 2004-349658

Patent Document 3: Japanese Patent (Granted) Publication No. 5,476,511

### SUMMARY OF THE INVENTION

Solid electrolytic capacitors which use an anode body containing tungsten as the main component (hereafter referred to as a “tungsten anode body”) are still at the stage of being the subject of ongoing investigations, and the difficulty associated with satisfactorily suppressing the leakage current is proving problematic.

Further, as a result of intensive investigation, the inventors of the present invention found out that solid electrolytic capacitors which use this type of tungsten anode body also suffer from a large variation in capacitance when the applied voltage is varied. Solid electrolytic capacitors that generate this type of variation in capacitance are limited in their potential applications. In other words, installing such solid electrolytic capacitors in electronic equipment having various design specifications has proven difficult. Further, even if installation were possible, there is a possibility that design of the equipment would be complex.

For example, Patent Document 2 discloses the use of an anode body containing tungsten to suppress the leakage current. However, the document makes no comment or suggestion regarding the variation in capacitance that occurs when the applied voltage is varied. In other words, the occurrence of the above problem when an anode body containing tungsten is used had not yet been reached.

In a further example, Patent Document 3 discloses the preparation of a capacitor element under specific treatment conditions in order to increase the capacitance in the high-frequency region. However, although the desirable effect of increasing the capacitance in the high-frequency region was able to be realized, the problem of variation in the capacitance when the applied voltage was varied was not reached.

The present invention has been developed in light of the above circumstances, and has an object of providing a method for manufacturing a chemical conversion treated tungsten anode body, a solid electrolytic capacitor element and a solid electrolytic capacitor, which exhibit minimal variation in capacitance when the applied voltage is varied and yield a low leakage current (LC value).

As a result of intensive investigation, the inventors of the present invention found out that by preparing a tungsten anode body under specific conditions, a method for manufacturing a chemical conversion treated tungsten anode body, a solid electrolytic capacitor element and a solid electrolytic capacitor which exhibit minimal variation in capacitance when the applied voltage is varied and yield a low leakage current (particularly the leakage current at voltages close to the chemical conversion voltage) was able to be obtained.

In other words, the present invention includes the aspects described below.

(1) A method for manufacturing a chemical conversion treated tungsten anode body according to one aspect of the present invention comprises a chemical conversion treatment step of subjecting the surface of a tungsten anode body to a chemical conversion treatment to form a dielectric layer, and a high-temperature treatment step of exposing the tungsten anode body with the dielectric layer formed thereon to an atmosphere having a temperature of 270° C. or more and 370° C. or less for a period of 3 to 8 minutes.

(2) In the method for manufacturing a chemical conversion treated tungsten anode body disclosed above in (1), the chemical conversion treatment may be performed at a temperature of 75° C. or more and 97° C. or less.

(3) The method for manufacturing a chemical conversion treated tungsten anode body disclosed above in (1) or (2) may be performed in an electrolyte solution containing either persulfuric acid or a persulfate salt.

(4) A method for manufacturing a solid electrolytic capacitor element according to another aspect of the present invention includes sequentially forming a semiconductor layer and a conductor layer on the surface of the chemical conversion treated tungsten anode body obtained by using the method disclosed above in any one of (1) to (3).

(5) A method for manufacturing a solid electrolytic capacitor according to yet another aspect of the present invention includes covering the solid electrolytic capacitor element obtained by using the method disclosed above in (4) with a resin exterior coating.

In the method for manufacturing a chemical conversion treated tungsten anode body according to one aspect of the present invention, by preparing the chemical conversion treated tungsten anode body under specific conditions, a chemical conversion treated tungsten anode body, a solid electrolytic capacitor element and a solid electrolytic capacitor can be obtained which exhibit minimal variation in capacitance when the applied voltage is varied and yield a low leakage current (particularly the leakage current at voltages close to the chemical conversion voltage).

### BRIEF DESCRIPTION OF THE DRAWINGS

FIG. 1 is a schematic cross-sectional view of a solid electrolytic capacitor.

### DETAILED DESCRIPTION OF THE INVENTION

A method for manufacturing a chemical conversion treated tungsten anode body, a solid electrolytic capacitor element and a solid electrolytic capacitor according to the present invention is described below in detail with appropriate reference to the drawing.

The drawing used in the following description may be drawn with specific portions enlarged as appropriate to facilitate comprehension of the features of the present invention, and the dimensional ratios and the like between the various constituent elements may differ from the actual values. Further, the materials and dimensions and the like presented in the following description are merely examples, which in no way limit the present invention, and may be altered as appropriate within the scope of the present invention.

### Solid Electrolytic Capacitor Element

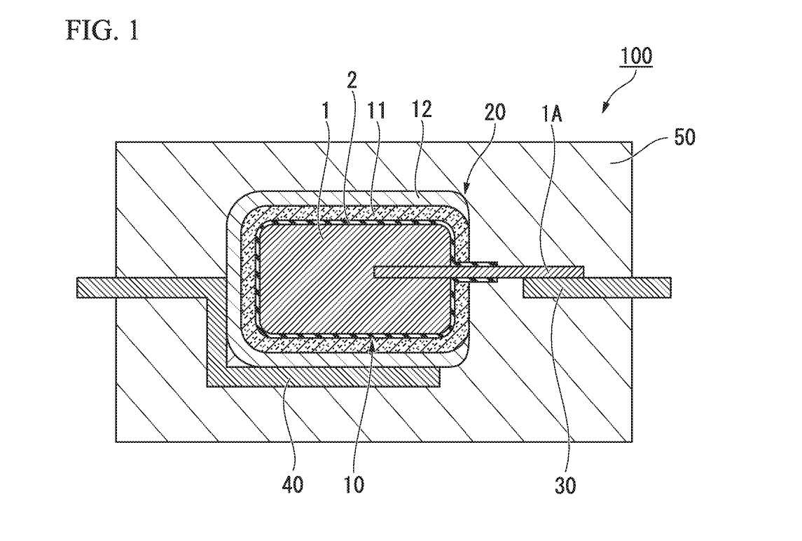

FIG. 1 is a schematic cross-sectional view of a solid electrolytic capacitor.

The solid electrolytic capacitor 100 of FIG. 1 contains a chemical conversion treated tungsten anode body 10 composed of a dielectric layer 2 formed on an anode body containing tungsten as the main component (a tungsten anode body) 1 and having an externally protruding anode lead wire 1A. A semiconductor layer 11 and a conductor layer 12 are formed in that order on the outer surface of the chemical conversion treated tungsten anode body 10 to generate a solid electrolytic capacitor element 20. Moreover, the anode lead wire 1A of the solid electrolytic capacitor element 20 is connected to an anode terminal 30, and the conductor layer 12 is connected to a cathode terminal 40. With the exception of portions of the anode terminal 30 and the cathode terminal 40, the entire structure is then covered with a resin exterior coating 50 to form the solid electrolytic capacitor 100. The conductor layer 12 and the cathode terminal 40 may also be connected via a conductive adhesive. By providing the resin exterior coating 50, the solid electrolytic capacitor element 20 can be protected from external effects. Further, a plurality of solid electrolytic capacitor elements may also be aligned in parallel to function as a single solid electrolytic capacitor.

The method for manufacturing the solid electrolytic capacitor 100 is described below in sequence, beginning with the chemical conversion treated tungsten anode body 10.

Method for Manufacturing Chemical Conversion Treated Tungsten Anode Body

The method for manufacturing the chemical conversion treated tungsten anode body 10 according to one aspect of the present invention comprises a chemical conversion treatment step of subjecting the surface of the tungsten anode body 1 to a chemical conversion treatment to form the dielectric layer 2, and a high-temperature treatment step of exposing the tungsten anode body with the dielectric layer 2 formed thereon to an atmosphere having a temperature of 270° C. or more and 370° C. or less for a period of 3 to 8 minutes.

First, the tungsten anode body 1 is prepared.

The tungsten anode body 1 is an anode body that contains tungsten as the main component. The tungsten anode body 1 can be obtained by providing an anode lead wire in a sintered body obtained by molding and sintering a tungsten powder.

The tungsten powder may be any powder containing tungsten as the main component. Here, the term “main component” means that tungsten represents at least 90% by mass of the total mass of the anode body. Further, the tungsten anode body 1 may be partially silicified. The tungsten anode body 1 may have a substantially rectangular parallelepiped shape, or a rectangular parallelepiped shape in which the corners of arbitrary surfaces have been chamfered to manufacture rounded corners. Further, the anode lead wire 1A is planted in, or connected to, one surface of the tungsten anode body 1.

Commercially available products may be used as the raw material tungsten powder. A tungsten powder having a small particle size is preferable, and a tungsten powder of smaller particle size can be obtained, for example, by grinding a tungsten oxide powder under a hydrogen atmosphere. Further, the tungsten powder may also be obtained by reducing tungstic acid or a salt thereof (such as ammonium tungstate) or a tungsten halide using a reducing agent such as hydrogen or sodium, with appropriate selection of the reduction conditions. Moreover, the tungsten powder can also be obtained from a tungsten-containing mineral, either directly or via a plurality of steps, by appropriate selection of the reduction conditions.

The raw material tungsten powder preferably has a 50% particle size (D50) in a volume-based cumulative particle size distribution that is within a range from 0.1 to 1 p.m. The tungsten powder may be a non-granulated powder (hereafter also referred to as a “primary powder”) or a granulated powder that has undergone granulation. The use of a granulated powder is preferable, as it facilitates the formation of pores in the capacitor anode body. Further, the granulated powder may be a powder in which the pore distribution has been adjusted, for example using the same method as that disclosed in Japanese Unexamined Patent Application, First Publication No. 2003-213302 for a niobium powder.

A powder in which either one or both of tungsten carbide and tungsten boride exist on a portion of the surface of the tungsten powder can also be used as the tungsten powder. Further, a powder containing nitrogen on a portion of the surface of the tungsten powder can also be used favorably.

Chemical Conversion Treatment Step

The dielectric layer 2 is formed on the surface of this tungsten anode body 1 by a chemical conversion treatment. Here, the “surface of the tungsten anode body 1” means the exterior surface of the tungsten anode body 1 and the surfaces of internal pores inside the tungsten anode body 1, and the dielectric layer 2 is formed on these surfaces.

The chemical conversion treatment can be performed by using conventionally used methods, and is performed by dipping the tungsten anode body in an electrolyte solution and then restricting the initial current and the voltage.

An electrolyte solution describes a solution prepared by dissolving an electrolyte in either water or a mixed solvent containing water and an organic solvent that is miscible with water.

For example, a solution containing an electrolyte such as nitric acid, sulfuric acid or ammonium persulfate can be used as the electrolyte solution. Among the various possibilities, an electrolyte solution containing persulfuric acid or a persulfate salt is preferred, and an electrolyte solution containing potassium persulfate or sodium persulfate is particularly preferred. By using these electrolyte solutions, the variation in capacitance when the applied voltage is varied can be further reduced. Further, the leakage current at voltages near the chemical conversion voltage can also be suppressed to a smaller value.

The chemical conversion treatment of the tungsten anode body 1 is preferably performed at a temperature of 75° C. or more and 97° C. or less. Provided the temperature is at least 75° C., the dielectric coating becomes more dense, meaning the LC value can be reduced. On the other hand, provided the temperature is not more than 97° C., the amount of the solvent that evaporates can be prevented from becoming too large, and boiling also does not occur. As a result, large changes in the treatment conditions over time can be suppressed, and the workability can be improved.

The chemical conversion treatment time is preferably set to the time taken for the electric current during the chemical conversion treatment to first fall, and then start to increase again. This is because while the electric current is falling, a uniform dielectric layer 2 is formed as the thickness of the layer gradually increases. This chemical conversion treatment time can be determined by performing preliminary testing in advance.

Further, a combination of a constant current and a constant voltage may also be used. For example, the chemical conversion treatment may be initiated at a constant current, and once the voltage has reached a preset chemical conversion voltage, the treatment may be continued at a constant voltage. In such a case, in a similar manner to that described above for the chemical conversion treatment time, the end point for the chemical conversion treatment can be set as the point where the current has fallen to a prescribed value.

By performing this type of chemical conversion treatment, a portion of the tungsten anode body 1 is oxidized to form the dielectric layer 2. As a result, the dielectric layer 2 contains tungsten oxide (WO3). Provided the dielectric layer 2 contains tungsten oxide, the layer may also include other compounds.

High-Temperature Treatment Step

Subsequently, the chemical conversion treated tungsten anode body 10 with the dielectric layer 2 formed thereon is exposed to an atmosphere having a temperature of 270° C. or more and 370° C. or less for a period of 3 to 8 minutes. By setting the temperature conditions and the treatment time for the high-temperature treatment to values within the above ranges, the variation in the capacitance when the applied voltage is varied for the obtained solid electrolytic capacitor can be reduced. Further, the leakage current at voltages near the chemical conversion voltage for the obtained solid electrolytic capacitor can also be reduced.

The temperature conditions effect the variation in the capacitance when the applied voltage is varied for the obtained solid electrolytic capacitor, and the leakage current at voltages near the chemical conversion voltage for the obtained solid electrolytic capacitor. If the temperature conditions are low, then the variation in the capacitance when the applied voltage is varied for the obtained solid electrolytic capacitor tends to increase, whereas if the temperature conditions are too high, then the leakage current at voltages near the chemical conversion voltage for the obtained solid electrolytic capacitor tend to increase. On the other hand, the treatment time has a large effect on the leakage current at voltages near the chemical conversion voltage for the obtained solid electrolytic capacitor. If the treatment time is too long or too short, then the leakage current increases.

Exposing the anode body to this type of high-temperature state can be achieved, for example, by placing (exposing) the chemical conversion treated tungsten anode body 10 in a heat treatment furnace. Conventional furnaces can be used as this heat treatment furnace. The rate at which the temperature is increased during the high-temperature treatment in this heat treatment furnace varies depending on the size of the chemical conversion treated tungsten anode body 10, the number of anode bodies, and the size of the heat treatment furnace, but is typically from 2 to 8° C. per minute. Furthermore, when taking the anode body out from the heat treatment furnace, the anode body is preferably taken once the temperature inside the heat treatment furnace has fallen to 200° C. or lower. This is because if the chemical conversion treated tungsten anode body 10 is exposed to a rapid temperature variation, then the difference in the coefficients of thermal expansion may generate the likelihood of cracking or splitting of the dielectric layer 2, causing an increase in the leakage current.

There are no particular limitations on the atmosphere during the high-temperature treatment. For example, the treatment may be performed in air, in a vacuum, or in an inert gas or the like. From the viewpoint of workability, the treatment is preferably performed in air.

By using a chemical conversion treated tungsten anode body 10 obtained in the manner described above, the variation in capacitance when the applied voltage is varied can be reduced. For example, in the case of a 10 V chemical conversion anode body that has been subjected to a chemical conversion treatment at 10 V, if the steps described above are not performed, then the reduction in the capacitance at an applied voltage of 2.5 V relative to the capacitance at an applied voltage of 0 V is 20% or greater. In contrast, when the steps described above are performed, the reduction in the capacitance at an applied voltage of 2.5 V relative to the capacitance at an applied voltage of 0 V can be suppressed to a value of 10% or less. In other words, a solid electrolytic capacitor 100 which uses this chemical conversion treated tungsten anode body 10 can be installed in electronic equipment having various design specifications. Further, the design of the equipment can be prevented from becoming overly complex.

The chemical conversion treated tungsten anode body 10 prepared by performing the steps described above can reduce the leakage current at voltages near the chemical conversion treatment voltage. For example, in the case of a 10 V chemical conversion anode body, the leakage current (LC value) for a chemical conversion treated tungsten anode body 10 that has been prepared via the steps described above is 0.02CV or less (wherein C represents the solution capacitance (F) of the anode body, V represents the chemical conversion voltage (V), and the units for the leakage current are μA). In contrast, in the case of an anode body that has not been subjected to the above steps, such a small leakage current cannot be realized.

It is thought that this reduced variation in the capacitance when the applied voltage is varied, and the small leakage current value at voltages near the chemical conversion treatment voltage are achieved for the reasons described below. It is thought that when the high-temperature treatment step is performed, a portion of the tungsten oxide within the dielectric layer 2 crystallizes. If a portion of the dielectric layer crystallizes, then the dielectric layer becomes more resistant to cracking or splitting than conventional amorphous dielectric layers. Accordingly, reduced variation in the capacitance when the applied voltage is varied, and a small leakage current value at voltages near the chemical conversion treatment voltage can be realized. The expression “a portion of the dielectric layer crystallizes” does not mean that large crystal growth occurs, but rather that very fine crystals appear and are scattered throughout the layer. Method for Manufacturing Solid Electrolytic Capacitor Element and Solid Electrolytic

Capacitor

The solid electrolytic capacitor element 20 is manufactured by sequentially forming the semiconductor layer 11 and the conductor layer 12 on the surface of the chemical conversion treated tungsten anode body 10 obtained by using the method described above. Further, the solid electrolytic capacitor 100 is then manufactured by covering the solid electrolytic capacitor element 20 with a resin exterior coating.

First, the semiconductor layer 11 is formed on the surface of the chemical conversion treated tungsten anode body 10. The semiconductor layer 11 can be formed from an inorganic semiconductor such as manganese dioxide or an organic semiconductor such as a conductive polymer, and may generally be formed using conventional methods.

The semiconductor layer is preferably formed from a conductive polymer, and can be formed, for example, by a chemical polymerization method and/or an electrolytic polymerization method. By using a chemical polymerization method and/or an electrolytic polymerization method, the semiconductor is formed even within the interior of fine pores in the chemical conversion treated tungsten anode body 10, and therefore the adhesion of the semiconductor layer 11 to the dielectric layer 2 can be improved. Further, these methods may also be split into a plurality of steps.

The chemical conversion treated tungsten anode body 10 may be dipped in a conductive polymer dispersion and then pulled up out of the dispersion, or the conductive polymer dispersion may be applied directly to the anode body and then solidified. There are no particular limitations on the solidification method, and typically employed drying methods or the like may be used. These dipping, application and drying steps may be repeated a plurality of times.

There are no particular limitations on the dispersion used for forming the semiconductor layer, provided it is a dispersion or a solution that can form a semiconductor when a current is passed through the dispersion or the solution. Examples include solutions containing aniline, thiophene, pyrrole, or substituted derivatives of these compounds (for example, 3,4-ethylenedioxythiophene) or the like. A dopant may also be added to the dispersion. There are no particular limitations on this dopant, and examples include conventional dopants such as aryl sulfonic acids or salts thereof, alkyl sulfonic acids or salts thereof, and various polymeric sulfonic acids or salts thereof. By using this type of dispersion for forming the semiconductor layer and passing a current through the dispersion, a semiconductor layer formed from a conductive polymer (such as polyaniline, polythiophene, polypyrrole, polymethylpyrrole or a derivative of any of these polymers) can be formed on the dielectric layer.

Further, the semiconductor layer may also be formed with a two-layer structure, by forming a first semiconductor layer using the chemical polymerization and/or electrolytic polymerization method described above, and then using a dipping-pulling method from a conductive polymer dispersion to form a second semiconductor layer on the first semiconductor layer.

In the above method, a post-conversion treatment is performed after formation of the semiconductor layer. By performing a post-conversion treatment, any defects or the like that have generated in the dielectric layer 2 can be repaired. In those cases where the semiconductor layer is formed via a plurality of repeated steps, this post-conversion treatment may be performed after formation of the entire semiconductor layer, or may be performed after each repetition.

Subsequently, the conductor layer 12 is formed on the semiconductor layer 11 to complete preparation of the solid electrolytic capacitor element 20.

There are no particular limitations on the conductor layer 12, and the use of highly conductive carbon or silver or the like is common. There are also no particular limitations on the preparation method, and the conductor layer may be prepared by solidifying a paste of carbon or silver. Further, these types of materials may also be laminated.

The solid electrolytic capacitor 100 can then be obtained by electrically connecting the anode lead wire 1A of the thus obtained solid electrolytic capacitor element 20 to the external anode terminal 30, electrically connecting the conductor layer 12 to the external cathode terminal 40, and then covering the element with the resin exterior coating 50.

### EXAMPLES

The present invention is described below in more detail based on a series of examples, but the present invention is in no way limited by these examples.

### Examples 1 to 5, Comparative Examples 1 to 5

First, 0.2% by mass of a silicon powder having a 50% particle size of 1 μm was mixed with a tungsten powder having a 50% particle size of 0.3 μm obtained by a hydrogen reduction of tungsten oxide, and the mixture was then calcined under vacuum at 1,160° C. for 30 minutes. After returning the mixture to room temperature, the lumps were taken out, crushed using a hammer mill, and then classified by sieving to obtain a granulated powder with a particle size of 26 to 180 μm. Subsequently, the granulated particles were molded in a molding machine, and then sintered under vacuum at 1,350° C. for 20 minutes to prepare 1,000 tungsten anode bodies each having a size of 1.0×1.7×2.3 mm (with a tantalum wire having a diameter of 0.24 mm implanted in the 1.0×2.3 mm surface, and having a mass of 32 mg±2 mg).

Next, 200 of the tungsten anode bodies were selected, each tungsten anode body, including a portion of the tantalum lead wire, was dipped in a 4% by mass aqueous solution of potassium persulfate, and a chemical conversion treatment was performed for 60 minutes at 10 V and 90° C., at an initial current of 5 mA per anode body, thus forming a dielectric layer composed of tungsten oxide.

The thus obtained chemical conversion treated tungsten anode bodies were each subjected to a high-temperature treatment by placing the anode body in a furnace at a temperature shown in Table 1 for a time period shown in Table 1, and then taking out the anode body. The high-temperature treatment was performed in an open atmosphere. Table 1 also includes values for the capacitance values (at a 0 V bias and a 2.5 V bias, each at 120 Hz) for the chemical conversion treated tungsten anode body following the high-temperature treatment, and the LC value upon application of 9 V (specifically, the value 30 seconds after applying the voltage at room temperature). The capacitance and LC values were measured using a 50% by mass aqueous solution of sulfuric acid as the measurement solution. Each measured value represents the average value of 10 anode bodies.

### Example 6

With the exception of altering the chemical conversion treatment temperature to 50° C., chemical conversion treated tungsten anode bodies were prepared in the same manner as Example 3. Measurements were performed for the capacitance at 0 V and 2.5 V, and the LC value at 9 V. The results are shown in Table 1.

### Comparative Example 6

With the exception of altering the temperature and time of the high-temperature treatment step to 165° C. and 3 minutes respectively, chemical conversion treated tungsten anode bodies were prepared in the same manner as Example 1. Measurements were performed for the capacitance at 0 V and 2.5 V, and the LC value at 9 V. The results are shown in Table 1.

### Example 7

With the exceptions of altering the electrolyte solution used in the chemical conversion treatment to a mixed aqueous solution containing 6% by mass of potassium persulfate and 1% by mass of sulfuric acid, and altering the chemical conversion treatment voltage to 15 V and the chemical conversion treatment temperature to 75° C., chemical conversion treated tungsten anode bodies were prepared in the same manner as Example 3. Measurements were performed for the capacitance at 0 V and 4 V, and the LC value at 13 V. The results are shown in Table 2.

The reduction in capacitance (%) shown in Table 1 and Table 2 was calculated using the following relational formula.

Reduction in capacitance (%)=100−(capacitance of chemical conversion treated tungsten anode body at a bias of 2.5 V or 4 V)/(capacitance of chemical conversion treated tungsten anode body at a bias of 0 V)×100

TABLE 1

| | Heat treatment | Capacitance (μF) | Capacitance (μF) | Reduction in | LC |
|---|---|---|---|---|---|
| | (temperature, time) | @ 0 V bias | @ 2.5 V bias | capacitance (%) | (μA) |
| Example 1 | 270° C., 8 minutes | 245 | 228 | 6.9 | 18 |
| Example 2 | 300° C., 5 minutes | 246 | 229 | 6.9 | 23 |
| Example 3 | 330° C., 5 minutes | 244 | 225 | 7.8 | 20 |
| Example 4 | 350° C., 5 minutes | 249 | 231 | 7.2 | 25 |
| Example 5 | 370° C., 3 minutes | 247 | 229 | 7.3 | 22 |
| Example 6 | 330° C., 5 minutes | 240 | 225 | 6.3 | 43 |
| Comparative | 260° C., 5 minutes | 360 | 226 | 37.2 | 57 |
| Example 1 | | | | | |
| Comparative | 380° C., 5 minutes | 252 | 221 | 12.3 | 104 |
| Example 2 | | | | | |
| Comparative | 190° C., 20 minutes | 331 | 220 | 33.5 | 54 |
| Example 3 | | | | | |
| Comparative | 350° C., 10 minutes | 248 | 220 | 11.3 | 115 |
| Example 4 | | | | | |
| Comparative | 270° C., 1 minute | 348 | 222 | 36.2 | 81 |
| Example 5 | | | | | |
| Comparative | 165° C., 3 minutes | 351 | 240 | 31.7 | 46 |
| Example 6 | | | | | |

TABLE 2

| | Heat treatment | Capacitance (μF) | Capacitance (μF) | Reduction in | LC |
|---|---|---|---|---|---|
| | (temperature, time) | @ 0 V bias | @ 4.0 V bias | capacitance (%) | (μA) |
| Example 7 | 330° C., 5 minutes | 185 | 174 | 5.9 | 14 |

### INDUSTRIAL APPLICABILITY

The capacitor anode body of the present invention is ideal for use as a solid electrolytic capacitor in a wide variety of fields, including in mobile telephones, personal computers and the like.

### DESCRIPTION OF THE REFERENCE SIGNS

1: Tungsten anode body
1A: Anode lead wire
2: Dielectric layer
10: Chemical conversion treated tungsten anode body
11: Semiconductor layer
12: Conductor layer
20: Solid electrolytic capacitor element
30: Anode terminal
40: Cathode terminal
50: Resin exterior coating
100: Solid electrolytic capacitor

1. A method for manufacturing an anode body containing tungsten, comprising;
subjecting a surface of a the anode body to a chemical conversion treatment to form a dielectric layer on the surface of the anode body, and
exposing the anode body covered with the dielectric layer to an atmosphere having a temperature range of 270° C. to 370° C. for 3 to 8 minutes.

2. The method for manufacturing the anode body according to claim 1, wherein the chemical conversion treatment is performed at a temperature range of 75° C. to 97° C.

3. The method for manufacturing the anode body according to claim 1, wherein the chemical conversion treatment is performed in an electrolyte solution comprising a persulfuric acid or a persulfate salt.

4. A method for manufacturing a solid electrolytic capacitor element, comprising:
forming a semiconductor layer on the dielectric layer formed on the surface of the anode body obtained by the method according to claim 1; and
forming a conductor layer on the semiconductor layer.

5. A method for manufacturing a solid electrolytic capacitor comprising;
covering the solid electrolytic capacitor element obtained by using the method according to claim 4 with a resin exterior coating.
